(19) United States
(12) Patent Application Publication
(10) Pub. No.: US 2010/0058837 A1
(43) Pub. Date: Mar. 11, 2010

(54) DEVICE HAVING MULTIPLE LIGHT SOURCES AND METHODS OF USE

(76) Inventors: William J. Quest, Dallas, TX (US); Kerry Whitaker, Plano, TX (US); James S. Winton, II, Keller, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 12/205,374

(22) Filed: Sep. 5, 2008

(51) Int. Cl. G01M 3/04; G21G 4/00

(52) U.S. Cl. 73/40; 356/51; 250/493.1

(57) ABSTRACT

A visualization device is described. The visualization device includes a body, one or more activating lights sources and one or more infrared light sources. The body is configured to receive one or more power sources. One or more infrared light sources are configured to determine temperature. The one or more activating light sources may be positioned at or proximate an end of the bode that is substantially opposite to the infrared light source and are configured to produce activating light. The activating light sources and the infrared light sources are separately or jointly coupled to one or more power sources. Methods of detecting leaks using the visualization device are also described.

### BACKGROUND

1. Field of the Invention

The present invention relates generally to a light-producing device. More particularly, the invention relates to a device having multiple light sources and methods of use.

2. Description of the Relevant Art

Leak detection methods have been developed to analyze mechanical systems using dyes that fluoresce or phosphoresce. These dyes may be added to the system, circulated through the system, and then the system may be inspected using an inspection lamp. The inspection lamp typically causes any dye leaking from the mechanical system to become visible, thus allowing a user to determine the origin of the leak. Once the origin of the leak is determined, the leak may be repaired mechanically or a sealant may be added to the system to stop the leak. Sealant compositions and dyes are described in U.S. Pat. No. 4,662,940 to Monier; U.S. Pat. No. 5,918,269 to Mchaffey, Jr.; U.S. Pat. No. 5,979,226 to Cavestri; U.S. Pat. No. 6,070,454 to Cavestri; U.S. Pat. No. 6,070,455 to Cavestri; 6,101,867 to Cavestri; U.S. Pat. No. 6,150,306 to Friswell; U.S. Pat. No. 6,165,384 to Cooper et al.; U.S. Pat. No. 6,170,320 to Scaringe et al.; U.S. Pat. No. 6,786,960 to Profetto; and U.S. Pat. No. 6,840,990 to Gallagher et al., all of which are incorporated herein by reference.

Conventional inspection lamps employ high intensity light sources (e.g., incandescent bulbs) that typically operate at high temperatures and may utilize filters to absorb undesirable wavelengths. In some instances, a broad-spectrum lamp is used as a light source. To produce UV light from a broad-spectrum lamp, a filter may be placed proximate to the light source to allow only ultraviolet (UV) wavelengths (i.e., light having a wavelength of less than 400 nm) to be transmitted while all of the remaining wavelengths are absorbed. These filters typically have a transmission efficiency of 50-70% for UV wavelengths. To compensate for the limited transmission efficiency, the power of the lamps may be high in wattage (e.g., 20 to 150 watts) and thus may require more energy from a power source.

Ultraviolet light sources (e.g., light emitting diodes and UV lights) used for detecting leaks are described in U.S. Pat. No. 7,122,812 to Kalley et al.; U.S. Pat. No. 7,141,811 to Trigiani; U.S. Pat. No. 6,590,220 to Kalley et al.; U.S. Pat. No. 6,855,944 to Trigiani; U.S. Pat. No. 6,767,110 to Cooper et al.; U.S. Pat. No. 6,710,363 to Trigiani; U.S. Pat. No. 6,491,408 to Cooper et al.; U.S. Pat. No. 6,355,935 to Kalley et al.; U.S. Pat. No. 6,095,661 to Lebens et al.; U.S. Pat. No. 5,959,306 to Kalley et al.; and U.S. Pat. No. 5,674,000 to Kalley et al. and U.S. Patent Application Nos. 2004/0124355 to Miniutti et al. and 2004/0150989 to Burke et al., all of which are incorporated herein by reference.

U.S. Pat. No. 6,630,682 to Shanley et al., which is incorporated herein by reference, describes a light that may be used both as a flashlight and a black light for ultraviolet (UV) inspection.

U.S. Pat. No. 7,066,621 to Booty, which is incorporated herein by reference, describes a dual-beam lantern-flashlight capable of emitting two light beams including an elongated flashlight body having a front end and a rear end. The headlamp and lantern lamp when in use together create a single large area of continuous light around the feet and forward of the user.

U.S. Patent Application Nos. 2006/0067071 to Quittner et al., which is incorporated herein by reference, describes light sources that can emit light other than white light. The single lamp can be a white light emitting diode (LED), a red LED in order to help preserve a user's night vision, an infrared LED for police and military night visions purposes, or an ultraviolet LED.

### SUMMARY

A visualization device is described herein. In some embodiments, the visualization device includes a body, one or more activating light sources, and one or more infrared light sources. The infrared light sources may be configured to produce infrared light. The activating light sources may be positioned opposite the infrared light sources and may be configured to produce activating light. In some embodiments, the visualization device includes a body, one or more infrared activating light sources one, or more activating light sources and/or one or more white light sources. The light sources are directly or separately coupled to one or more power sources positioned in the body cavity. In some embodiments, the visualization device may be provided as part of a kit.

Methods are also described for detecting leaks in one or more mechanical systems. In some embodiments, infrared light may be directed towards at least a portion of the mechanical system and the temperature of at least one component of the mechanical system is determined. Activating light from a visualization light may be directed towards the mechanical system. A leak may be detected when one or more of the light activated compounds are detected when using light produced by the visualization device.

In some embodiments, the mechanical system may contain one or more fluids. White light from a visualization device may be directed towards at least a portion of the mechanical system to illuminate fluid flowing from a leak in the mechanical system. Activating light from the visualization device may be directed towards at least a portion of the mechanical system. A leak may be detected by observing the presence of one or more light activated compounds exiting the mechanical system.

Methods are also described herein for treating mechanical systems so that leaks may be detected and sealed. In some embodiments, a composition may include a carrier fluid, a mechanical system sealant, and a light activated compound. The mechanical system sealant may at least partially seal leaks in the mechanical system during use. The light activated compound may be white to the human eye when activated with an activating light source. For example, the light activated compound may fluoresce when treated with activating light. A mechanical system that is or suspected of having a leak may be treated with the composition. The mechanical system sealant may seal one or more leaks in the system. The mechanical system may then be inspected to determine if any light activated compounds are leaking from the system and, particularly, portions of the system in which a leak was suspected or known.

### BRIEF DESCRIPTION OF THE DRAWINGS

FIG. 1 is a top view of an embodiment of a visualization device.

FIG. 2 is a top view of the interior of the visualization device depicted in FIG. 1.

FIG. 3 is a top view of an embodiment of a visualization device.

FIG. 4 is a first end view of visualization device of FIG. 3.

FIG. 5 is a side of the visualization device of FIG. 3.

FIG. 6 is a second end view of the visualization device of FIG. 3.

FIG. 7 is a top view on an embodiment of a visualization device that includes an infrared light source.

FIGS. 8A and 8B are side views on an embodiment of a visualization device that includes an infrared light source and two function switches.

FIGS. 8C and 8D are top views on an embodiment of a visualization device that includes an infrared light source and two function switches.

FIG. 9 is a top view of the interior of the visualization device depicted in FIGS. 8A and 8B.

### DETAILED DESCRIPTION

A visualization device that includes at least 2 light sources and methods of use are described herein. Terms used herein are as follows:

“Activating light source” refers to a light source that emits light that causes a visible change to a property of a light activated compound (e.g., a color change or fluorescence of the compound). Examples of activating light sources include, but are not limited to, ultraviolet light source (i.e., light sources that produce light below about 400 nm), and light emitting diodes that emit light below 550 nm, (e.g., blue light emitting diodes, and green light emitting diodes).

“Directly attached” refers to direct connection between objects or components (i.e., connection without any intervening components).

“Indirect connection” refers to forming a connection between two components through one or more intervening components.

“Light activated compounds” refer to a compound or compounds that are visible to the human eye when exposed to activating light.

“Periodic Table” refers to the Periodic Table as published by the International Union of Pure and Applied Chemistry on Nov. 7, 2003.

“Sealant” refers to a compound, a mixture of compounds, particles, or combinations thereof that inhibit passage of liquid and/or gas from one area to a different area.

“White light” refers to mixture of light having wavelengths in the range of 380 nm to 800 nm.

Inspection of a mechanical system for leaks and/or failure may be performed with two sources of light, a visual light source and an activating light source. Typically, an inspector will need to carry at least two different light producing devices to perform the inspection, for example, a white light source and an ultraviolet light source. The white light source may be used to inspect the portion of the mechanical system that ambient lighting would make difficult to see. The ultraviolet light source may be used to inspect a portion of the mechanical system that has been treated with fluorescent dyes.

In some embodiments, a visualization device includes a white light source and an infrared light source. In certain embodiments, a visualization device includes an infrared light source and an activating light source. In some embodiments, a visualization device includes an infrared light source, an activating light source and/or a white light source. The infrared light source may be directed at a component of a mechanical system (e.g., a vent, a pump, an engine, etc.) to determine a temperature of the component. Determination of the temperature of the components of the mechanical system may assist in the overall assessment of the performance of the mechanical system.

A visualization device that includes at least two different sources as described herein may be more convenient and less cumbersome than having to carry two types of visualization devices that only include a single light source. The visualization device as described herein may increase efficiency of mechanical system inspections due to the ease of changing from one type of light source to another type of light source.

The visualization device may include a body having removable ends. One or more light sources and one or more lenses may be positioned at each end of the body. One or more function switches positioned on the surface of the housing may control the light sources. The visualization device may be handheld and portable. In some embodiments, a total length of the visualization device is at most 10 inches, at most 7 inches, at most 6 inches, or at most 5 inches.

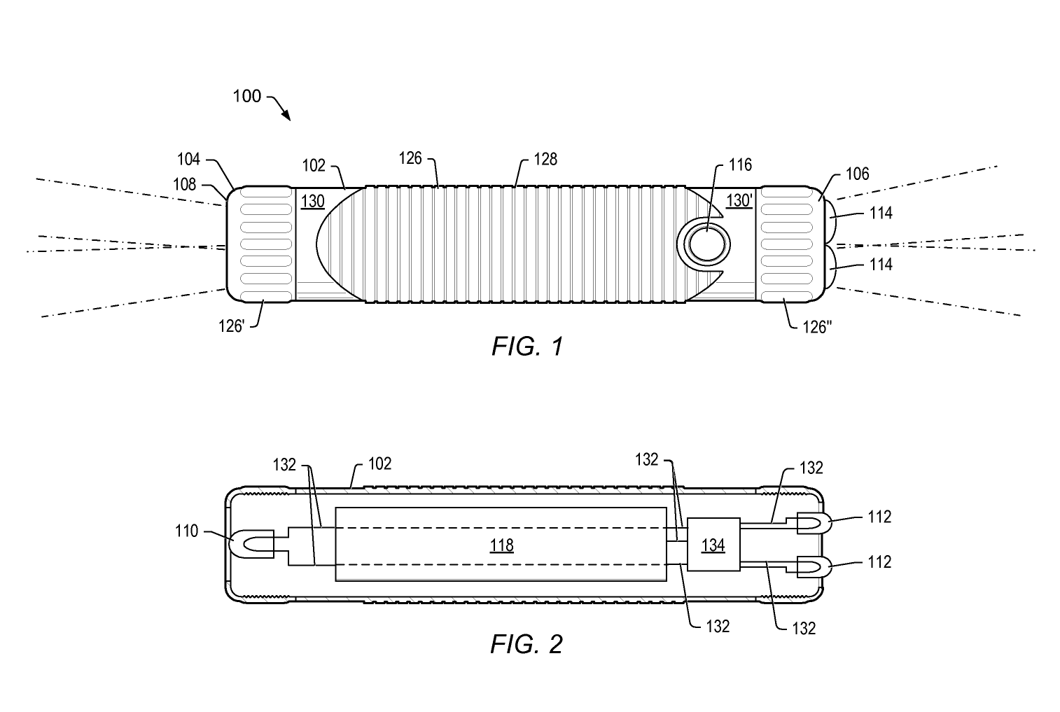

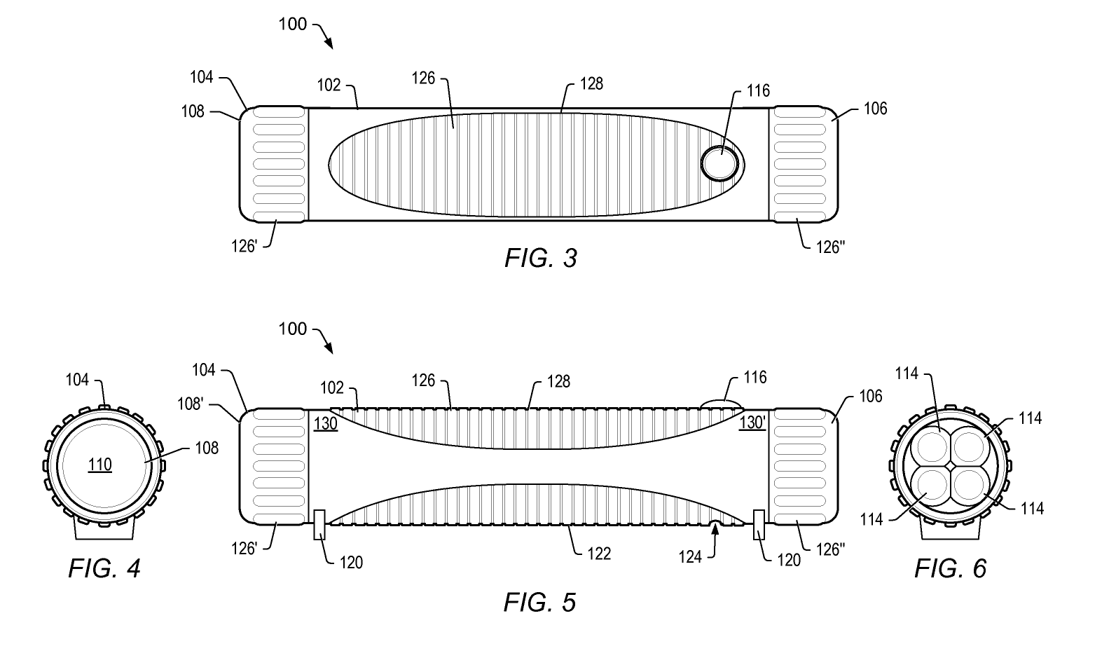

FIGS. 1 and 3 depict visualization devices having at least two light sources. FIG. 2 depicts an interior top view of the visualization device depicted in FIG. 1 with the ends removed. FIGS. 4 and 6 depict end views of the visualization device depicted in FIG. 3. Visualization device 100 includes body 102, first end 104, second end 106, white light outlet 108, white light source 110 (FIGS. 2 and 6), activating light sources 112 (FIGS. 2 and 6), activating light outlets 114 and function switch 116.

Body 102 may be any shape suitable for holding the components of the visualization device (e.g., a rectangular shape, a cylindrical shape, or an elongated cylindrical shape). In some embodiments, the shape of body 102 may be rectangular with rounded edges. Body 102 may be constructed of phenolic resin, acrylics, polycarbonate, plastic, pre-tensioned plastic, aluminum, metal alloy, or other material suitable for holding the components of the visualization device. Body 102 may include a cavity to hold power source 118. Power source 118 includes, but is not limited to, one or more dry cell batteries, one or more rechargeable batteries, one or more power packs, or any power source known in the art that is suitable to power the light sources. Examples of power sources include, but are not limited to, AAA batteries, AA batteries, or 9-volt batteries.

As shown in FIG. 5, body 102 includes projections 120. Projections 120 may allow visualization device 100 to be elevated from a surface (e.g., countertop, benchtop, car engine, car hood, air conditioning unit, etc.). Elevation of visualization device 100 from a surface may prevent the visualization device from rolling.

In some embodiments, body 102 includes a removable portion that allows power source 118 to be positioned in the cavity of the body. As shown in FIG. 5, body 102 may include removable portion 122. Removable portion 122 and body 102 may include opening 124 so that a fastener (e.g., screw, pin or any fastener known in the art) may attach the removable portion to the body. In some embodiments, power source 118 is inserted in the cavity of body 102 after removal of first end portion 104 or second end portion 106.

As shown in FIGS. 1, 3, and 5, a portion of an outer surface of body 102 may include ridges 126 and grooves 128. In certain embodiments, outer surface of body 102 is textured. Texturing and/or ridges 126 may enhance gripping of utility light 100. In some embodiments, one or more portions of the outer surface of body 102 are smooth.

In certain embodiments, ridges 126 and grooves 128 are part of a cover that may be positioned over the outer surface of body 102. The cover may be coupled or directly attached to the outer surface of body 102. In the context of this patent, the term “coupled” means either a direct connection or an indirect connection between one or more objects or components. In some embodiments, the cover may be removable and/or slideably coupled to body 102.

Outer surface of body 102 may be painted, dyed, or constructed of a colored material. In some embodiments, portions 130, 130′ of outer surface of body 102 may be a different color from the color of ridges 126 and grooves 128. Colors include, but are not limited to, black, white, red, orange, yellow, green, blue, indigo, violet, or hues of such colors. In certain embodiments, portion 130, may be a different color than portion 130′. In some embodiments, ridges 126, grooves 128, and portions 130, 130′ are all the same color or shade of color. In some embodiments, outer surface of body 102 may include icons and/or text to assist an end user of visualization device 100 in identifying which end of the utility light contains the visual light source or the activating light source. Having different visual indicators such as colors, icons and/or text positioned on portions of outer surface of body 102 may assist an operator of utility light 100 in identifying which portion of the visualization device produces the desired light. For example, outer surface portion 130′ may be a first color (e.g., red), outer surface portion 130′ may be a second color (e.g., blue) different from the first color, and ridges 126 and grooves 128 may be a third and/or fourth color, different than the first or second colors.

First end 104 may removably couple to body 102. A shape of first end 104 may be complimentary to an end of body 102 (e.g., cylindrical in shape). In some embodiments, first end 104 threadly couples to body 102. In certain embodiments, one or more pins engage one or more slots to couple first end 104 to body 102. In certain embodiments, first end 104 is directly attached to body 102. In some embodiments, body 102 includes a washer that positions under first end 104 to enhance sealing of the first end with the body.

First end 104 includes ridges 126′ to enhance gripping of the end. Ridges 126′ may be constructed of the same material as first end 104. In some embodiments, ridges 126′ may be constructed of rubber and/or other suitable material to enhance gripping of first end 104. A color of ridges 126′ may be the same or different than a color of first end 104. In some embodiments, first end 104 includes grooves to enhance gripping. In other embodiments, first end 104 has a smooth texture.

First end 104 may include a visual indicator such as a color, icon, text, or combinations thereof to indicate the function of the light source 110. In some embodiments, a color of first end 104 may be different than the color of body 102. In some embodiments, a color and/or a material of first end 104 may be the same as ridges 126 and grooves 128 of outer surface of body 102. For example, ridges 126 and grooves 128 of outer surface of body 102 and first end 104 may all be black polymeric material.

First end 104 includes a light outlet 108. Light outlet 108 allows light from white light source 110 (see FIG. 2 and FIG. 4) to exit body 102. Light outlet 108 may included a cover constructed of glass or plastic. In some embodiments, light outlet 108 is a lens. White light source 110 includes, but is not limited to, a white light emitting diode (LED), an array of LEDs, one or more incandescent bulbs, one or more fluorescent lights, or any light source capable of illumination.

Second end 106 may removably couple to body 102. A shape of second end 106 may be complimentary to an end of body 102 (e.g., cylindrical in shape). Second end 106 includes activating light sources 112. In some embodiments, second end 106 threadly couples to body 102. In certain embodiments, one or more pins engage one or more slots to couple second end 106 to body 102. In certain embodiments, second end 106 is directly attached to body 102. In some embodiments, body 102 includes a washer that positions under second end 106 to enhance sealing of the end with the body.

Second end 106 includes ridges 126″ to enhance gripping of the end. Ridges 126″ may be constructed of the same material as second end 106. In some embodiments, ridges 126″ may be constructed of rubber and/or other suitable material to enhance gripping of second end 106. A color of ridges 126″ may be the same or different than a color of second end 106. In some embodiments, second end 106 includes grooves to enhance gripping. In other embodiments, second end 106 has a smooth texture.

Second end 106 may include a visual indicator such as a color, icon, text, or combinations thereof to indicate the function of the light source. In some embodiments, a color of second end 106 may be different than the color of body 102. In some embodiments, a color and/or a material of second end 106 may be the same as ridges 126 and grooves 128 of outer surface of body 102 and/or first end 104. For example, ridges 126 and grooves 128 of outer surface of body 102 and second end 106 and/or first end 104 may all be black polymeric material.

Second end may include activating light outlets. One or more activating light outlets 114 allow activating light from one or more activating light sources 112 (see FIG. 2 and FIG. 6) to exit body 102. Activating light outlets 114 may include a cover constructed of glass or plastic. In some embodiments, one or more activating light outlets 114 include a lens. In some embodiments, activating light source 112 is an array of LEDs and second end 106 has one activating light outlet 114. In certain embodiments, second end 106 may include a lip that includes activating light outlet 114. As shown in FIG. 1, activating light outlets 114 extend past second end 106. As shown in FIGS. 3 and 5, activating light outlets 114 are recessed in second end 106. Activating light sources 112 include activating light sources that emit light at a wavelength below 525 nm, below 500 nm, below 475 nm, below 425 nm, below 400 nm, below 350 nm, or combinations thereof. Activating light sources include, but are not limited to, a green LED, a blue LED, a UV LED, an organic LED, or combinations thereof. In some embodiments, the activating light source is a halogen lamp and/or any light source capable of emitting light below 400 nm. Activating light sources 112 may be an array of LEDs. Activating light sources 112 are positioned in body 102 such that the activating light sources emit light at about 100 degrees, about 150 degrees, or about 180 degrees with respect to light emitted from the white light source 110.

White light source 110 and activating light sources 112 may be coupled to body 102 using known techniques in the art. For example the light sources may be soldered to body 102, be positioned in socket configuration, or a combination of thereof.

In some embodiments, a size of LED light sources used in the utility light described herein may range from about 1 millimeter (mm) to about 10 mm, about 2 mm to about 9 mm, about 3 mm to about 8 mm, about 4 mm to about 7 mm, or about 5 mm to about 6 mm. The LEDs may be a diffuse type LED or a non-diffuse type LED. A diffuse type LED spreads light to a viewing angle of ±35 degree from center. A non-diffuse type of LED provides a narrow light to a viewing angle of ±15 degrees form center. UV LED light sources used in the light sources described herein may have a light intensity ranging from about 400 to about 405 nm. The white light used in the light sources described herein is a Super Bright UV LED 3.2-3.4 V manufactured by Super Bright LEDs, Inc. (St. Louis, Mo., USA). LED light sources are described in U.S. Pat. No. 7,138,667 to Barnett et al.; U.S. Pat. No. 6,917,057 to Stokes et al.; U.S. Pat. No. 6,9033,80 to Barnett et al., U.S. Pat. No. 6,561,680 to Shih; U.S. Pat. No. 6,541,800 to Barnett et al.; U.S. Pat. No. 6,274,924 to Carey et al.; U.S. Pat. No. 6,6069,440 to Shimizu et al.; and U.S. Pat. No. 5,578,839 to Nakamura et al., all of which are incorporated herein by reference. LED light sources can be obtained from Phillips Lumileds Lighting Company (San Jose, Calif., USA), Hangzhou Z-Light Optoelectronics Co., Ltd. (Zhejiang, China); Vishay Americas (Shelton, Conn., USA); SunLED (Walnut, Calif., USA); Kingbright Corporation (Taipei), Hosfelt Electronics (Steubenville, Ohio), and Super Bright LEDs, Inc. (St. Louis, Mo., USA).

A top view of the inside of utility light 100 is depicted in FIG. 2. White light source 110 and activating light sources 112 are connected through circuitry 132 to control component 134. In some embodiments, one or more white light sources and one or more activating light sources are separately or jointly coupled to one or more power sources. In some embodiments, activating light sources and white light sources are all coupled to the same power source. In some embodiments, one or more white light source may be coupled to one battery and one or more activating light sources may be coupled to another battery. In some embodiments, one or more white light sources may be coupled to one or more activating light sources and the activating light source is coupled to one or more batteries. In some embodiments, a wall is positioned between two batteries. One or more activating light sources are coupled to one of the two batteries. One or more white lights sources are coupled to the other battery.

In some embodiments, power source 118 includes 3 AA dry cell batteries. In some embodiments, the cavity may include one or more connector structures that may assist in connecting the power source to the control component. Control component 134 is coupled to function switch 116. Control component 134 includes the necessary components such as resistors, switches, capacitors or other components known in the art to regulate power to the light sources of visualization device 100. In some embodiments, visualization device 100 may include more than one control component.

Contact of function switch 116 sends a signal to control component 134 to activate power source 118 to turn one or both of the light sources of visualization device 100 on or off. Control component 134 includes components and/or chips to control activating light sources 112 and/or white light source 110. Function switch 116, in combination with control component 134, may be used to control which light source is activated. For example, contact of function switch 116 a predetermined number of times may control activation and deactivation of the light sources. For example, contact of function switch 116 once may send a signal to control component 134 to turn on activating light sources 112 while leaving white light sources off. Contact of function switch 116 twice may send a signal to control component to turn off activating light sources 112 and turn on white light source 110. Contact of function switch 116 a third time may send a signal to control component 134 to turn off white light source 110. It should be understood that the sequence of activation and deactivation can be altered and all possible combinations of activation and deactivation, including use of more than three activation signals are possible for controlling the visualization device. For example, in an alternate embodiment, contact of function switch 116 a first time sends a signal to control component 134 to turn on all light sources. Contact of function switch 116 a second time sends a signal to control component 134 to turn off the light sources.

In some embodiments, function switch 116 may be a push button, which may be depressed to control the activation and deactivation of the light sources. In other embodiments, function switch 116 may be a slide type switch, key-type switch toggle switch or multiple-position switch. In one embodiment, pushing or sliding function switch 116 towards second end 106 activates activating light sources 112. Pushing or sliding the function switch towards first end 104 activates white light source 110. Positioning function switch 116 in a middle position deactivates all light sources.

In some embodiments, the visualization device includes a body, one or more activating light sources, and one or more infrared light sources. The infrared light sources may be may be configured to produce infrared light so that a temperature of a portion of a mechanical system may be determined. The activating light sources may be positioned at or proximate an end of the body that is substantially opposite the infrared light sources and may be configured to produce activating light. In some embodiments, the infrared light sources and/or activating light sources may be positioned in a cavity of the body. In some embodiments, the visualization device one or more infrared activating light sources one, or more activating light sources and/or one or more white light sources. The light sources are directly or separately coupled to one or more power sources positioned in the body cavity. In some embodiments, the light sources are directly coupled to one or more controller components positioned in the cavity of the body. In some embodiments, the visualization device may be provided as part of a kit.

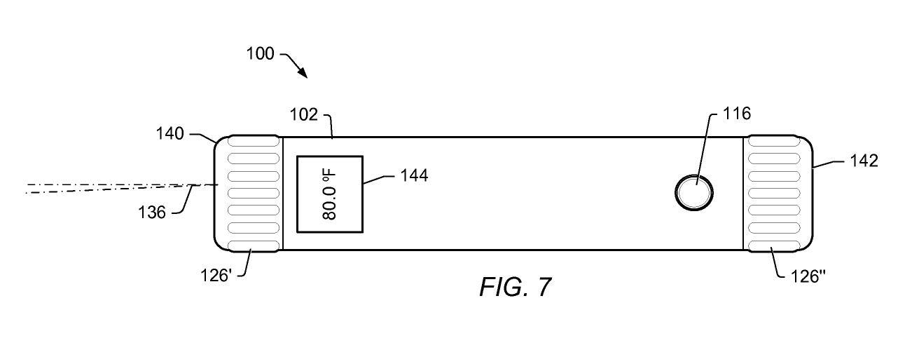

FIG. 7 depicts a top view of visualization device 100 that includes infrared light source 136. Visualization source 100 may include infrared light source 136, first end 140, body 102, second end 142, display panel 144, activating light sources 112. Infrared light source 136 includes, but is not limited to, a laser or infrared bulb. In some embodiments, visualization source includes one or more infrared light source, one or more activating light sources and/or one or more white light sources.

Body 102 includes components to allow detection of a temperature and display of the temperature on the display panel 144. Such components may include, but not limited to, an infrared sensor sensitive to infrared radiation, a detector, optics, electronics to convert the signal from the detector to a display. Infrared light sources for temperature measurement are described in U.S. Pat. No. 5,169,234, to Bohm; U.S. Pat. No. 5,823,679 to Hollander et al.; U.S. Pat. No. 6,69,639 to Hollander et al. and U.S. Pat. No. 6,868,678 to Mei et al., all of which are herein incorporated by reference.

Display panel 144 may display the temperature in degrees Fahrenheit and/or degrees Celsius. Display panel may include a toggle switch that allows the temperature reading to be changed from degrees Fahrenheit to degrees Celsius or degrees Celsius to degrees Fahrenheit.

First end 140 may removably couple to body 102. A shape of first end 140 may be complimentary to an end of body 102 (e.g., cylindrical in shape). In some embodiments, first end 140 threadly couples to body 102. In certain embodiments, one or more pins engage one or more slots to couple first end 140 to body 102. In certain embodiments, first end 140 is directly attached to body 102. In some embodiments, body 102 includes a washer that positions under first end 140 to enhance sealing of the first end with the body.

First end 140 includes ridges 126′ to enhance gripping of the end. Ridges 126′ may be constructed of the same material as first end 140. In some embodiments, ridges 126′ may be constructed of rubber and/or other suitable material to enhance gripping of first end 140. A color of ridges 126′ may be the same or different than a color of first end 140. In some embodiments, first end 104 includes grooves to enhance gripping. In other embodiments, first end 140 has a smooth texture.

First end 140 may include a visual indicator such as a color, icon, text, or combinations thereof to indicate the function of the infrared light source 136. In some embodiments, a color of first end 140 may be different than the color of body 102. In some embodiments, a color and/or a material of first end 140 may be the same as ridges 126 and grooves 128 of outer surface of body 102. For example, ridges 126 and grooves 128 of outer surface of body 102 and first end 140 may all be black polymeric material.

Second end 142 may removably couple to body 102. A shape of second end 142 may be complimentary to an end of body 102 (e.g., cylindrical in shape). Second end 142 includes activating light sources (not shown). In some embodiments, second end 142 includes activating light sources and white light sources. The activating light sources may be the same as those described for FIGS. 1-6. In some embodiments, second end 142 threadly couples to body 102. In certain embodiments, one or more pins engage one or more slots to couple second end 142 to body 102. In certain embodiments, second end 142 is directly attached to body 102. In some embodiments, body 102 includes a washer that positions under second end 142 to enhance sealing of the end with the body.

Second end 142 includes ridges 126″ to enhance gripping of the end. Ridges 126″ may be constructed of the same material as second end 142. In some embodiments, ridges 126″ may be constructed of rubber and/or other suitable material to enhance gripping of second end 142. A color of ridges 126″ may be the same or different than a color of second end 142. In some embodiments, second end 142 includes grooves to enhance gripping. In other embodiments, second end 142 has a smooth texture.

Function switch 116 may be positioned near second end 142. In some embodiments, function switch 116 includes a visual indicator such as a color, icon, text, or combinations thereof to indicate the function of the light sources. Function switch 116, in combination with control component 134 (see for example, FIGS. 2 and 9), may be used to control which light source is activated. For example, contact of function switch 116 a predetermined number of times may control activation and deactivation of the activating light sources and/or infrared light sources and/or white light sources as described for FIGS. 1-6.

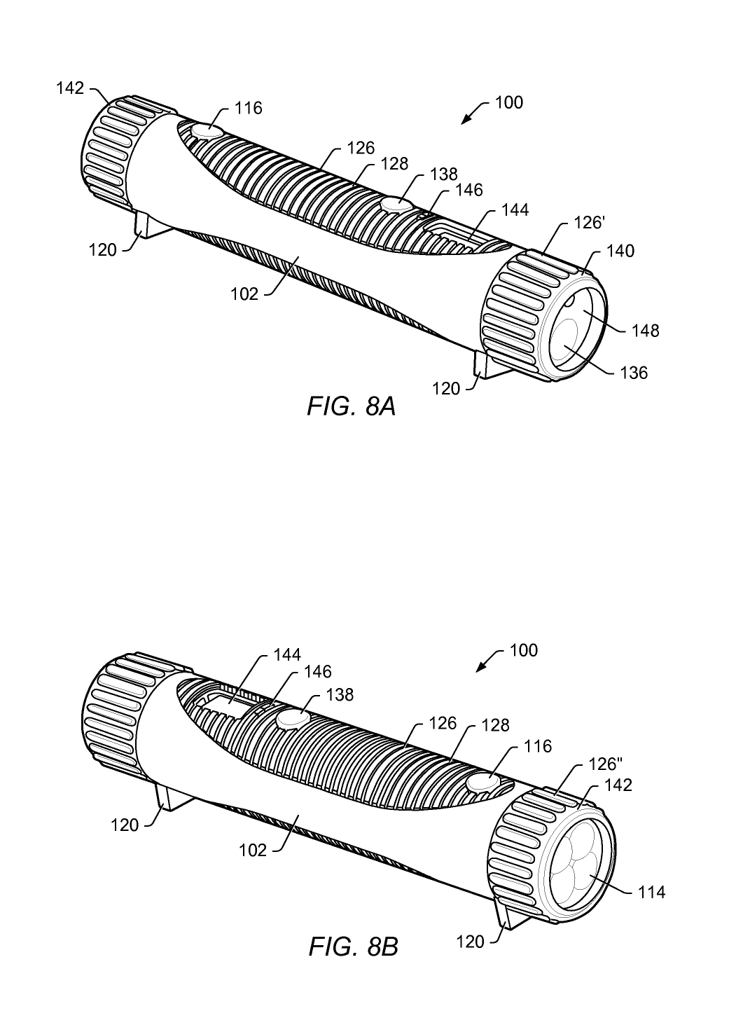

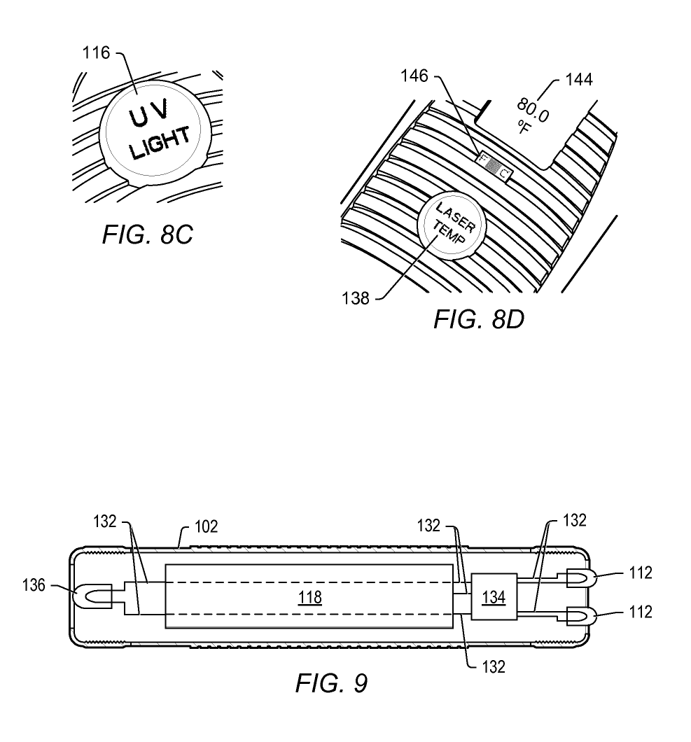

FIGS. 8A through 8D depict views of visualization device 100 that includes infrared light source 136 and two function switches 116, 138. FIG. 9 is a top view of the interior of the visualization device depicted in FIGS. 8A, and 8B. Visualization source 100 may include infrared light source 136, first end 140, body 102, second end 142, display panel 144, and activating light sources (see FIG. 9). Infrared light source 136 includes, but is not limited to, a laser or infrared bulb. In some embodiments, visualization source includes one or more infrared light sources, one or more activating light sources and/or one or more white light sources. The activating light sources and/or white light sources may be the same as those described for FIGS. 1-6.

Body 102 includes components to allow detection of a temperature and display of the temperature on the display panel 144. Such components may include, but not limited to, an infrared sensor sensitive to infrared radiation, a detector, optics, electronics to convert the signal from the detector to a display. Infrared light sources for temperature measurement are described in U.S. Pat. No. 5,169,234, to Bohm; U.S. Pat. No. 5,823,679 to Hollander et al.; U.S. Pat. No. 6,69,639 to Hollander et al. and U.S. Pat. No. 6,868,678 to Mei et al.

Display panel 144 may display the temperature in degrees Fahrenheit and/or degrees Celsius. As shown in FIGS. 8A, 8B and 8D, display panel includes toggle switch 146 that allows the temperature reading to be changed from degrees Fahrenheit to degrees Celsius or degrees Celsius to degrees Fahrenheit. Sliding toggle switch 146 allows the temperature reading to be changed from degrees Fahrenheit to degrees Celsius or degrees Celsius to degrees Fahrenheit. In some embodiments, toggle switch 146 is a push button.

First end 140 may removably couple to body 102. A shape of first end 140 may be complimentary to an end of body 102 (e.g., cylindrical in shape). In some embodiments, first end 140 threadly couples to body 102. In certain embodiments, one or more pins engage one or more slots to couple first end 140 to body 102. In certain embodiments, first end 140 is directly attached to body 102. In some embodiments, body 102 includes a washer that positions under first end 140 to enhance sealing of the first end with the body.

First end 140 includes ridges 126′ to enhance gripping of the end. Ridges 126′ may be constructed of the same material as first end 140. In some embodiments, ridges 126′ may be constructed of rubber and/or other suitable material to enhance gripping of first end 140. A color of ridges 126′ may be the same or different than a color of first end 140. In some embodiments, first end 104 includes grooves to enhance gripping. In other embodiments, first end 140 has a smooth texture.

First end 140 may include a visual indicator such as a color, icon, text, or combinations thereof to indicate the function of the infrared light source 136. In some embodiments, a color of first end 140 may be different than the color of body 102. In some embodiments, a color and/or a material of first end 140 may be the same as ridges 126 and grooves 128 of outer surface of body 102. For example, ridges 126 and grooves 128 of outer surface of body 102 and first end 140 may all be black polymeric material.

As shown in FIG. 8A, first end 140 includes a light outlet 148. Light outlet 148 allows light from infrared light source 136 to exit body 102. Light outlet 148 may include a cover constructed of glass or plastic. In some embodiments, light outlet 148 includes one or more lenses. In some embodiments, first end 140 includes one or more infrared light sources, one or more white light sources and/or one or more activating light sources. Infrared light source 136 is positioned in body 102 such that the infrared light source emits light at about 100 degrees, about 150 degrees, or about 180 degrees with respect to light emitted from the opposite end of body 102.

Second end 142 may removably couple to body 102. A shape of second end 142 may be complimentary to an end of body 102 (e.g., cylindrical in shape). In some embodiments, second end 142 threadly couples to body 102. In certain embodiments, one or more pins engage one or more slots to couple second end 142 to body 102. In certain embodiments, second end 142 is directly attached to body 102. In some embodiments, body 102 includes a washer that positions under second end 142 to enhance sealing of the end with the body.

Second end 142 includes ridges 126″ to enhance gripping of the end. Ridges 126″ may be constructed of the same material as second end 142. In some embodiments, ridges 126″ may be constructed of rubber and/or other suitable material to enhance gripping of second end 142. A color of ridges 126″ may be the same or different than a color of second end 142. In some embodiments, second end 142 includes grooves to enhance gripping. In other embodiments, second end 142 has a smooth texture.

As shown in FIG. 8B, second end 142 includes light outlets 114. One or more activating light outlets 114 allow activating light from one or more activating light sources 112 (see FIG. 9) to exit body 102. Activating light outlets 114 may include a cover constructed of glass or plastic. In some embodiments, one or more activating light outlets 114 include a lens. In some embodiments, activating light source 112 is an array of LEDs and second end 106 has one activating light outlet 114. In certain embodiments, second end 106 may include a lip that includes activating light outlet 114. As shown in FIG. 8B, activating light outlets 114 extend past second end 142. Activating light sources 112 include activating light sources that emit light at a wavelength below 525 nm, below 500 nm, below 475 nm, below 425 nm, below 400 nm, below 350 nm, or combinations thereof. Activating light sources include, but are not limited to, a green LED, a blue LED, a UV LED, an organic LED, or combinations thereof. In some embodiments, the activating light source is a halogen lamp and/or any light source capable of emitting light below 400 nm. Activating light sources 112 may be an array of LEDs. Activating light sources 112 are positioned in body 102 such that the activating light sources emit light at about 100 degrees, about 150 degrees, or about 180 degrees with respect to light emitted from the white light source 110.

As shown in FIGS. 8A and 8B, function switch 138 may be positioned near the first end 138 and function switch 116 may be positioned near second end 142. As shown in 8C and 8D, function switches 138 and 116 include text to indicate which function switch operates which light source. In some embodiments, function switches 138 and 116 include a visual indicator such as a color, icon, text, or combinations thereof to indicate the function of the light sources. In some embodiments, a color of function switch 116 may be different than the color of function switch 138.

FIG. 9 is a top view of the interior of the visualization device depicted in FIGS. 8A, and 8B. Infrared light source 136 and activating light sources 112 are connected through circuitry 132 to control component 134. In some embodiments, infrared light sources and white light sources are connected through similar circuitry to a control component. In an embodiment, infrared light sources, white light sources and activating light sources are connected through similar circuitry to a control component. In some embodiments, one or more control components are used. In some embodiments, all light sources are coupled to power source 118. In some embodiments, one or more infraredlight sources and one or more activating light sources are separately or jointly coupled to one or more power sources. In some embodiments, activating light sources and infrared light sources are all coupled to the same power source. In some embodiments, one or more infrared light source may be coupled to one battery and one or more activating light sources may be coupled to another battery. In some embodiments, one or more infrared light sources may be coupled to one or more activating light sources and the activating light source is coupled to one or more batteries. In some embodiments, a wall is positioned between two batteries. One or more activating light sources are coupled to one of the two batteries. One or more infrared lights sources are coupled to the other battery. In some embodiments, power source 118 includes 3 AA dry cell batteries. In some embodiments, the cavity may include one or more connector structures that may assist in connecting the power source to the control component. Control component 134 is separately or jointly coupled to function switches 116 and 138. In some embodiments, visualization device has more than one control component.

Contact of function switch 116 and/or 138 sends a signal to control component 134 to activate power source 118 to turn one or all of the light sources of visualization device 100 on or off. Control component 134 includes components and/or chips to control activating light sources 112. Function switch 116, in combination with control component 134, may be used to control which activating light sources 112. Function switch 138 in combination with control component 134, may be used to control infrared light source 136. For example, contact of function switch 138 may turn on infrared light source 136. Contact of function switch again may turn off infrared light source 136.

In some embodiments, function switches 116, 138 may be push buttons, which may be depressed to control the activation and deactivation of the light sources. In other embodiments, function switches 116, 138 may be slide type switches, key-type switch toggle switch or multiple-position switch. In one embodiment, pushing or sliding function switch 116 towards second end 140 activates activating light sources 112. Pushing or sliding the function switch 138 towards first end 140 activates infrared light source 136. In some embodiments, function switch 116 controls activating light sources 112 positioned in second end 142 while function switch 138 control the infrared light sources positioned in first end 140.

In some embodiments, the visualization device may be packaged and sold as a kit. The kit may include safety glasses (e.g., white lens or UV safety glasses), towels, funnels, a visualization device, batteries, or combinations thereof. The kit may be packaged in a carrying case with pre-formed segments to hold the components of the kit. In some embodiments, the carrying case may be plastic and/or include a handle. In some embodiments, the preformed segments may be removable.

The visualization device described herein may be used to help detect leaks in one or more mechanical systems. Mechanical systems include, but are not limited to, heat transfer systems, air conditioning systems, engine systems, power steering systems, transmission systems, hydraulic systems, or combinations thereof. Heat transfer systems include, but are not limited to, air conditioning systems, heating systems, venting systems, refrigeration systems or combinations thereof. Air conditions systems include, but are not limited to, vehicle and building air conditioning systems.

In certain embodiments, mechanical systems may exhibit leaks that may be observed by the human eye. For example, droplets of fluid may be observed on a surface of a component of the mechanical system and/or on a surface beneath the mechanical system (e.g., the ground, an asphalt surface, a cement surface, and/or a tile surface). Mechanical system may also exhibit leaks that may not be readily detected by the human eye. Fluid from leaks that develop when the mechanical system is being operated may disperse into the air without being detected. Color and/or cleanliness of the mechanical equipment may prevent leaks from being visible to the human eye. Some leaks are small and may be difficult to detect. Leaks in a mechanical system may result in diminished performance of the mechanical system. Poor mechanical performance may cause mechanical failure or diminish the efficiency of the components of the system.

In certain embodiments, leaks may be inhibited in mechanical systems by replacement of seals, gaskets, hoses, or other components. Replacement of mechanical system components may be expensive and/or time consuming. The ability to inhibit or stop a leak without replacement of mechanical components may allow the mechanical system to be operated without loss of time (“downtime”) due to repairing components of the mechanical system. Limited downtime may enhance productivity of commercial operations that rely on mechanical systems for transportation and/or power.

In some embodiments, after the mechanical system has been operated for a period of time and after repairing a leak in the mechanical system, the mechanical system may be inspected with the visual light source of the visualization device described herein to determine if the leak has ceased. Alternatively, a light activated compound may be added to the mechanical system, circulated through the system, and the system may be inspected using the activating light source of the visualization device described herein. If no fluid droplets and/or dye visualization is observed, the leak is determined to be stopped.

In certain embodiments, dyed smoke is used to initially locate a leak. Visualization of the dyed smoke can be performed using the visual light and/or activating light sources of the utility light described herein.

Early detection of a different leak in the mechanical system or of a leak from the same area in the mechanical system may prevent lost time and/or expensive repairs. Typically, most dyes used for detection decompose and/or vaporize after the mechanical system is operated for a period of time.

In various types of leak testing of mechanical systems, a light activated compound and/or dye may be added to the mechanical system, circulated through the system, and detected using the visualization device described herein. Light activated compounds may include fluorescent dyes and/or phosphorescent dyes. Fluorescent dyes and/or phosphorescent dyes may have a visible color or may be colorless. In some embodiments, fluorescent dyes may not be visible to a human eye, but may become visible when the fluorescent dye is exposed to (e.g., UV light, blue light, green light). In some embodiments, a light activated compound may remain substantially unchanged when heated up to 1000° C., up to 800° C., up to 600° C., or up to 400° C. Light activated compounds may be available as a solid or a liquid. In some embodiments, from about 0.0001 grams to about 10 grams, from about 0.001 grams to about 1 gram, or from about 0.01 grams to about 0.1 gram of light activated compound per 100 grams of mechanical system fluid may be added to the mechanical system. Fluids of mechanical systems include, but are not limited to, hydraulic oil, engine oil, transmission fluid, power steering fluid, halogenated hydrocarbons, hydrocarbons, synthetic hydrocarbons, alkylbenzenes, polyalphaolefins, synthetic polyalkylene glycol lubricants, polyester lubricants, or combinations thereof.

Light activated compounds include, but are not limited to, the following compounds or derivatives of the following compounds: anthracenes, aminoalklyphenothiazines, aminophenylbenzothiazoles, benzothiazolines, benzothiazoles, benzotriazoles, carbazoles, coumarins, diphenylamines, fluoresceins, naphthalenes, naphthalamides, naphthylamides, naphthalimides, phenanthracenes, phenothiazines, perylenes, pyrollidones, phenols, quinolines, isoquinolines, purines, thioxanes, thioxanthanes, and 1,3,4-thiadiazoles. Examples of these compounds include, but are not limited to, coumarin 6; coumarin 7; coumarin 30; coumarin 6H; coumarin 102; coumarin 110; coumarin 152; coumarin 153; coumarin 314; coumarin 334; coumarin 337; coumarin 343; coumarin 480D; coumarin-3-carboxylic acid; 7-(2H-naphtho[1,2-D]triazol-2-yl)-3phenylcoumarin; 2-aminobenzothiazole; benzothiazole; N-phenyl-1-naphthylamine; N-phenyl-2-naphthylamine; N-(4-cumylphenyl)-1-naphthylamine; p-tert-dodecylphenyl-2-naphthylamine; 2,2-dimethylbenzothiazoline; bis(benzothiazoline), benzotriazole; methylene bis(dibutyl dithiocarbamate); 2,6-di-tert-butyl-4-methylphenol; 2,5-dimercapto-1,3,4-thiadiazole; dioctyldiphenylamine; didecyldiphenylamine; or 1-methyl-2-pyrollidone, N,N′-dialkyl-4-amino-1,8-naphthalimides, alkoxyalkyl4-amino-1,8naphthalimides, N-ethyl-4(aminoethyl)-1,8-naphthalimide, N-n-propyl-4(amino-n-propyl)-1,8-naphthalimide, N-n-butyl-4(amino-n-butyl)1,8-naphthalimide, N-n-pentyl-4(amino-n-pentyl)-1,8-naphthalimide, N-n-hexyl-4(amino-n-hexyl)-1,8-naphthalimide, N-n-octyl-4(amino-n-octyl)-1,8-naphthalimide, N-n-decyl-4(amino-n-decyl)-1,8-naphthalimide, N-iso-butyl-4(amino-iso-butyl)-1,8-naphthalimide; N-(3-methoxypropyl)-4-amino-(3-methoxypropyl)-1,8-naphthalimide, N-(3-ethoxypropyl)-4-amino-(3-ethoxypropyl)-1,8-naphthalimide, N-(3-isopropoxypropyl)-4-amino-(3-isopropoxypropyl)-1,8-naphthalimide, N-(3-n-butoxypropyl)-4-amino-(3-n-butoxypropyl)-1,8-naphthalimide, naphthalimide diesters, and naphthoxanthenes. Organic metallics such as molybdenum dialkylphosphorodithioate and zinc octyldithio-phosphate; and inorganic compounds such zinc sulfide and cadmium sulfide also may be used as light activated compounds.

Light activated compounds are described in U.S. Pat. No. 6,248,890 to Likavec et al.; U.S. Pat. No. 5,858,930 to Desai et al.; U.S. Pat. Nos. 5,279,967, 5,149,453 to Parekh, 4,172,202 to Papenfuhs, all of which are incorporated herein by reference. Light activated compounds are commercially available as STAY BRITE® BSL 712, STAY BRITE® BSL 713, STAY BRITE® BSL 714 (Bright Solutions, Troy Mich., U.S.A.), DAY GLOW® TRY-33 (Day Glow Color Corp, Cleveland, Ohio, U.S.A.), R-12 dye (part 16252, SPX Corporation, Robinair, Montpelier, Ohio, U.S.A.), or R-134a dye (part 16253, SPX Corporation, Robinair, Montpelier, Ohio, U.S.A.), D15000 (Chromatech, Inc., Canton, Mich., U.S.A.), Solvent Yellow 43 (Keystone Aniline Corporation, Chicago, Ill., U.S.A.), Part no. 399006, (UView Ultraviolet Systems, Inc., Mississauga, Ontario, Canada). Other sources for light activated compounds are Aldrich Chemical Co. (Milwaukee, Wis., U.S.A.), and Rohm and Haas (Philadelphia, Pa., U.S.A.).

In some embodiments, visible dyes (e.g., green, blue or red dyes) may be added to the mechanical system. In some embodiments, dyes may be used to differentiate from other leak detecting and/or leak sealing products. In some embodiments, up to 1 gram, up to 0.5 grams, or up to 0.01 grams of dye per 100 grams of mechanical system fluid may be added to a mechanical system.

In some embodiments, a mechanical system may be treated with a light activated compound and/or dye to detect leaks in mechanical systems. The light activated compound and/or dye may be added directly to the mechanical system through a port. In some embodiments, the mechanical system may be treated with the light activated compound and/or dye at the site of manufacture. Addition of the light activated compound and/or dye at the site of manufacture may enable leaks that develop during the manufacturing process and/or during shipment of new machinery to be detected. Addition of additive fluid to an air conditioning system is described in U.S. Pat. No. 6,851,442 to Kalley et al., U.S. Pat. No. 6,481,221 to Ferris et al., and U.S. Pat. No. 6,385,986 to Ferris et al., and U.S. Patent Application Publication Nos. 2005/0081914 to Kalley et al. and 2005/0272844 to Kalley et al., all of which are incorporated by reference herein.

In some embodiments, the light activated compound and/or dye may be pre-mixed with an appropriate fluid to form a fluid/light activated compound and/or dye mixture. Once mixed, the fluid/light activated compound and/or dye mixture may be added to the mechanical system though the port of the mechanical system. Once added to the mechanical system, the light activated compound is circulated through the mechanical system for a period of time. For example, the light activated compound may be circulated by starting the system and operating the system at least 1 minute, at least 30 minutes, at least 60 minutes, at least 4 hours, at least 8 hours, at least 3 days, at least 4 days, or up to 1 week. After circulating the composition through the mechanical system, activating light (e.g. UV light) from the visualization device described herein may be directed towards a portion (e.g., the exterior) of one or more components of the mechanical system. If a leak is present in the mechanical system, any light activated compound leaking from the system would become visible to the eye when activated by the activating light.

Visualization of the light activated compound(s) with the activating light source portion of the utility light described herein may indicate the source(s) of leak(s). Once the source of the leak is detected, the light activated compound may be removed from the site of the source. For example, a person may wipe a cloth over components of the mechanical system to remove any light activated compound from the components.

In some embodiments, the light activated compound and/or visual dye may be sold and/or packaged as part of a kit. The kit may include one or more of the following: a composition, safety glasses and/or UV safety glasses, towels, funnels, a visualization device as described herein, and batteries. The kit may be packaged in a carrying case with pre-formed segments complementary to the components included in the kit. In some embodiments, the carrying case may be plastic and/or include a handle. In some embodiments, the pre-formed segments may be removable.

In some embodiments, a non-aqueous composition that includes mechanical system sealant and a light activated compound may be used to detect and seal one or more leaks in the mechanical system. Such compositions and sealants are described in U.S. Published Patent Nos. 20070087946 to Quest et al., 20070087945 to Quest et al., and 20070084269 to Quest et al., all of which are incorporated herein by reference.

The composition may include a carrier fluid, a mechanical system sealant, and a light activated compound. The composition may also include additives such as pour point depressants, viscosity modifiers, friction modifiers, extreme pressure additives, dispersants, antifoamants, metal deactivators, surfactants, preservatives, corrosion inhibitors, antioxidants, fragrances, visible dyes, or mixtures thereof.

A carrier fluid may include fluids that are compatible with the mechanical system. For example, engine oil and fuel used in an engine oil system, refrigerant and refrigerant lubricant used in an air-conditioning system and/or refrigeration system, power steering fluid, transmission fluid, etc. Examples of carrier fluids include, but are not limited to, hydrocarbons, refined petroleum compounds, alcohols, polyalcohols (e.g., polyalkylene glycol (PAG)), esters, polyol esters, alcohol ethers, poly-alpha olefins (PAO), silicone fluids, or mixtures thereof.

Hydrocarbons include compounds that are composed of only hydrogen and carbon. In some embodiments, hydrocarbons that are useful as a carrier fluid include compounds having at least five carbon atoms. In some embodiments, hydrocarbons having a carbon number from 5 to 50, from 10 to 40, or from 20 to 30 may be used as a carrier fluid. Hydrocarbons include, but are not limited to, alkyl compounds, olefins, aryl compounds, cyclic compounds, or mixtures thereof. Examples of hydrocarbons that may be used as a carrier fluid include, but are not limited to, hexane, toluene, substituted toluene, benzene, substituted benzenes, cycloparaffins, cyclohexanes, naphthalene, octanes, iso-octane, or mixtures thereof. In some embodiments, the composition may include from about 0.1 grams to about 99 grams, from about 1 gram to about 90 grams, from about 10 grams to about 80 grams, from about 20 grams to about 70 grams, from about 30 grams to about 60 grams, or from about 40 grams to about 50 grams of hydrocarbons per 100 grams of composition.

Refined petroleum compounds include compounds that have been produced from hydrocarbon sources (e.g., oil). In some embodiments, refined petroleum compounds may include, but are not limited to, hydrocarbons, compounds containing heteroatoms (e.g., sulfur, nitrogen, or phosphorus), compounds having a carbon number of at least 1, or mixtures thereof. In some embodiments, refined petroleum compounds include a mixture of cycloparaffins and aromatics (e.g., naphthenic oils). For example, refined petroleum compounds may include greater than 80 grams, greater than 90 grams, or greater than 99 grams of naphthenic oil per 100 grams of refined petroleum compounds. In some embodiments, the refined petroleum compounds may have a viscosity in a range from about 50 SUS to about 150 SUS, from about 75 SUS to about 125 SUS, or from about 90 SUS to about 110 SUS at 100° C.

Poly-alpha olefins include compounds having a molecular weight from about 600 to about 3,000,000 and result from the polymerization of one or more alpha-olefins. Examples of alpha-olefins that may be converted to poly-alpha olefins include, but are not limited to, ethylene, propylene, 1-butene, 1-pentene, 4-methyl-1-pentene, 1-hexene, or mixtures thereof. In some embodiments, the composition may include from about 0.01 grams to about 50 grams, from about 0.1 grams to about 30 grams, or from about 1 gram to about 20 grams of poly-alpha olefins per 100 grams of composition.

“Alcohols” refer to compounds having at least one hydroxy (OH) group. In some embodiments, alcohols include compounds having the general formula of CₙH₂ₙ₊₁OH, where n is at least 1. Examples of alcohols include, but are not limited to, methanol, ethanol, propanol, iso-propanol, butanol, sec-butanol, tert-butanol, or mixtures thereof. In some embodiments, alcohols may be combined with a carrier fluid to enhance solubility and/or dispersion of a mechanical system sealant, a light activated compound, additives, or mixtures thereof combined in the carrier fluid.

“Esters” refer to compounds or mixtures of compounds having the general formula of RCO₂R′ where R and R′ are alkyl and/or aryl. Examples of esters include, but are not limited to, methyl acetate, ethyl acetate, stearin, palmitin, methyl butanoate, methyl salicylate, methyl benzoate, ethyl methanoate, ethyl butanoate, pentyl ethanoate, pentyl pentanoate, pentyl butanoate, octyl ethanoate, methyl stearate, esters of dicarboxylic acids, or mixtures thereof. Examples of esters of dicarboxylic acids include, but are not limited to alkyl or aryl esters formed from: phthalic acid, succinic acid, alkyl succinic acids and alkenyl succinic acids, maleic acid, azelaic acid, suberic acid, sebacic acid, fiunaric acid, adipic acid, linoleic acid dimer, malonic acid, alkyl malonic acids, alkenyl malonic acids, 1,2-benzenedicarboxylic acid diisononyl ester, or mixtures thereof. Esters may be combined with a carrier fluid to enhance solubility and/or dispersion of a mechanical system sealant, light activated compounds, additives, or mixtures thereof that are combined with the carrier fluid. Esters may, in some embodiments, be used as a fragrance in the composition. In some embodiments, the composition may include from about 0.01 grams to about 50 grams, from about 0.1 grams to about 30 grams, or from about 1 gram to about 20 grams of ester per 100 grams of composition.

Polyol esters include, but are not limited to, glycerol esters, sorbitan esters, pentaerythritolesters, trimethylolpropane esters, or mixtures thereof. In some embodiments, the composition may include from about 0.01 grams to about 50 grams, from about 0.1 grams to about 30 grams, or from about 1 gram to about 20 grams of esters per 100 grams of composition.

In some embodiments, esters may include phosphate esters. Examples of phosphate esters include, but are not limited to, dialkyl phosphate esters, alkyl diaryl phosphate esters (e.g., 2-ethylhexyl diphenyl phosphate or isodecyl diphenyl phosphate), diaryl phosphate esters, triarylphosphate esters (e.g., tricresyl phosphate or isopropylated triphenyl phosphate ester), butylated triphenyl phosphate ester (e.g., tetra-butyl triphenyl phosphate), trimester alkyl phosphate esters (e.g., trisbutoxyethyl phosphate), or mixtures thereof. In some embodiments, esters containing a heteroatom may be used as extreme-pressure additives, anti-wear additives, plasticizers, or flame-retardants. In some embodiments, the composition may include from about 0.01 grams to about 50 grams, from about 0.1 grams to about 30 grams, or from about 1 gram to about 20 grams of phosphate esters per 100 grams of composition.

“Alcohol ethers” refer to compounds or a mixture of compounds having the general formula of H(OCH₂CH₂)ₙOR′, where R″ is alkyl and/or aryl, and n is at least 1. Examples of alcohol ethers include, but are not limited to, cellulose ethers, grafted polyol ethers, and ethylene glycol ethers (e.g., glycol propyl ether, ethylene glycol monobutyl ether, or ethylene glycol monobenzyl ether). In some embodiments, alcohol ethers may be combined with a carrier fluid to enhance solubility and/or dispersion of a mechanical system sealant, a light activated compound, additives, or mixtures thereof that are combined in the carrier fluid. In some embodiments, the composition may include from about 0.01 grams to about 50 grams, from about 0.1 grams to about 30 grams, or from about 1 gram to about 20 grams of alcohol ethers per 100 grams of composition.

Antioxidants include, but are not limited to, metal salts of dialkyl dithiophosphates, alkylated diphenyl amines, sulfurized alkylphenols and phenolates, hindered phenols, or mixtures thereof. Metals of metal salts of dialkyl dithiophosphates include, but are not limited to, metals from Columns 6-12 of the Periodic Table (e.g., zinc, cadmium, or molybdenum). In some embodiments, the composition may include from about 0.001 grams to about 10 grams, from about 0.01 grams to about 5 grams, or from about 0.1 grams to about 1 gram of antioxidant per 100 grams of composition.

Antifoamants include, but are not limited to, silicones, polysilicones, or mixtures thereof. In some embodiments, the composition may include from about 0.00001 grams to about 1 gram, from about 0.0001 grams to about 0.1 grams, or from about 0.001 grams to about 0.01 grams of antifoamant per 100 grams of composition.

Corrosion inhibitors include, but are not limited to, metal salts of dialkyl dithiophosphates, metal sulfonate salts, metal phenolate salts, or mixtures thereof. Metals of metal sulfonates and metal phenolates include, but are not limited to, metals from Columns 1 and 2 of the Periodic Table (e.g., calcium, barium, sodium, or magnesium). In some embodiments, the composition may include from about 0.0001 grams to about 10 grams, from about 0.001 grams to about 1 gram, or from about 0.01 grams to about 0.1 grams of corrosion inhibitor per 100 grams of composition.

Dispersants include, but are not limited to, polyisobutylene succinate esters, Mannich Base ashless dispersants, or mixtures thereof. In some embodiments, a polyisobutylene portion of a succinate ester may have a molecular weight ranging from about 500 to about 3,000 or from about 900 to from 2,500. In some embodiments, the composition may include from 0.5 grams to about 10.0 grams or from about 1 gram to about 3 grams of dispersant per 100 grams of composition.

Extreme-pressure additives include, but are not limited to, amine salts of phosphoric acids, dibenzyl polysulfides, di-tert-nonyl polysulfides, didodecyl polysulfides, di-tert-butyl polysulfides, dioctyl polysulfides, diphenyl polysulfides, dicyclohexyl polysulfides, zinc dithiophosphate, molybdenum sulfides, molybdenum organosulfides, or mixtures thereof. Extreme-pressure additives, in some embodiments, may perform as metal-deactivators, anti-wear additives, corrosion inhibitors, and/or friction modifiers. In some embodiments, the composition may include from about 0.01 grams to about 30 grams, from about 0.1 grams to about 20 grams, or from about 1 gram to about 10 grams of extreme-pressure additives per 100 grams of composition.

Friction modifiers may include, but are not limited to, alkane phosphonic acids, alkanols, amides, amines, alkanolamides, alkoxylated amines, alkoxylated ether amines, amine oxides, amidoamines, amino guanidines, amine salts, betaines, borated glycerol monooleates, glycerol esters of dimerized fatty acids, esters of carboxylic acids, esters of anhydrides, fatty acid esters, imidazolines, imines, nitriles, organo-molybdenum compounds, molybdenum dialkyldithiocarbamates, molybdenum dialkyl dithiophosphates, molybdenum disulfide, tri-molybdenum cluster dialkyldithiocarbamates, non-sulfir molybdenum compounds, quaternary amines, or mixtures thereof. Friction modifiers may, in some embodiments, perform as extreme-pressure additives, corrosion inhibitors, metal deactivators, and/or anti-wear additives. In some embodiments, the composition may include from about 0.01 grams to about 10 grams or from about 0.1 grams to about 1 gram of friction modifiers per 100 grams of composition.

Pour point depressants include, but are not limited to, polyacrylates, polymethacrylates, copolymers of ethylene and propylene, or polymers having a molecular weight from about 20,000 to about 120,000. In some embodiments, the composition may include from about 0.01 grams to about 10 grams or from about 0.1 gram to about 1 grams of pour point depressant per 100 grams of composition.

Viscosity modifiers include, but are not limited to, polyisobutylene, copolymers of ethylene and propylene and higher alpha-olefins, polymethacrylates, polyalkylmethacrylates, methacrylate copolymers, copolymers of an unsaturated dicarboxylic acid and a vinyl compound, inter polymers of styrene and acrylic esters, and partially hydrogenated copolymers of styrene/isoprene, styrene/butadiene, and isoprene/butadiene, as well as the partially hydrogenated homopolymers of butadiene and isoprene and isoprene/divinylbenzene. In some embodiments, the composition may include from about 0.01 grams to about 20 grams or from about 1 gram to about 10 grams of viscosity modifier per 100 grams of composition. In some embodiments, viscosity modifiers may function as a dispersant.

Surfactants include, but are not limited to, anionic surfactants, cationic surfactants, non-ionic surfactants, amphoteric surfactants, or mixtures thereof. In some embodiments, surfactants may enhance the miscibility of the composition with the fluid in the mechanical system. Examples of anionic surfactants include, but are not limited to, phenates, salicylates, overbased sulfonates, neutral sulfonates, or linear alkyl benzene sulfonates. Examples of cationic surfactants include, but are not limited to, alkyl pyridinium compounds and/or quaternary ammonium compounds. Examples of amphoteric surfactants include, but are not limited to, imidazolines and betaines. Examples of nonionic surfactants include, but are not limited to, alkyl phenol ethoxylates, alkyl ethoxylates, alkylpolyglycosides, polyhydroxy long-chain carboxylic acid amides, long-chain carboxylic acid salts, sulfonates, phosphonates, sulfate and phosphate-based compounds capable of dissolving in water, or mixtures thereof. “Long-chain carboxylic acids” refer to saturated and unsaturated carboxylic acids having between 6 and 30 carbon atoms. In some embodiments, the composition may include from about 0.01 grams to about 30 grams, from about 0.1 grams to about 20 grams, or from about 1 gram to about 10 grams of surfactant per 100 grams of composition.

Carrier fluids and/or additives are commercially available from Asahi Denka Kogyo K. K. (Japan), Akzo Nobel Chemicals (Netherlands), Chevron Oronite (Houston, Tex., U.S.A.), Chemtura (Middlebury, Conn., U.S.A.), Degussa-RohMax USA (Horsham, Pa., U.S.A.), ExxonMobile Co. (Houston, Tex., U.S.A.), Infineum (United Kingdom), Lubrizol (Cleveland, Ohio, U.S.A.), R. T. Vanderbilt Company, Inc. (Norwalk, Conn.), Shell Chemical Co. (Houston, Tex., U.S.A.), or Shell Oil Co. (Houston, Tex., U.S.A.). In some embodiments, a mixture of carrier fluid, one or more additives, and/or light activated compounds may be commercially available as a formulated package.

The composition may include a mechanical system sealant capable of stopping and/or inhibiting the leak. The mechanical system sealant may include material such as polymeric materials, plasticizers, synthetic fibers, cellulose fibers, or combinations thereof. Polymeric materials include, but are not limited to, latex, polyvinyl acetate, polyvinyl resins, or mixtures thereof.

Plasticizers include, but are not limited to, phthalate esters, aliphatic dibasic acid esters, trimellitates, pyromellitic acid esters, phosphates, and/or refined hydrocarbons. In some embodiments, a mixture of aromatic hydrocarbons, diisononyl phthalate, and dialkyl phosphate esters may perform as a sealant for the mechanical system. Examples of phthalate esters such as di(2-ethylhexyl)phthalate, butyl benzyl phthalate, dinonyl phthalate, diisononyl phthalate, diisodecyl phthalate, diundecyl phthalate, diheptyl phthalate, butyl phthalyl, butyl glycolate. Examples of aliphatic dibasic acid esters include dioctyl adipate, didecyl adipate, dioctyl sebacate; polyglycol benzoates such as polyoxyethylene glycol dibenzoate, polyoxypropylene glycol dibenzoate.

In some embodiments, the composition may include from about 1 gram to about 99 grams, from about 10 grams to about 90 grams, from about 20 grams to about 80 grams, from about 30 grams to about 70 grams, or from about 40 grams to about 60 grams of sealant per 100 grams of composition.

The mechanical system sealant may be dispersed or emulsified in the carrier fluid. In some embodiments, the mechanical system sealant may swell when heated in the mechanical system. A swellable material may allow mechanical system sealant of relatively small diameter to be introduced into the mechanical system and not be removed by filters positioned in the mechanical system. The mechanical system sealant may enlarge (swell) as the composition is circulated through the mechanical system.

In some embodiments, visible dyes may be added to the fluid of the mechanical system. In some embodiments, dyes may be used to differentiate the composition from other leak detecting and/or leak sealing products. A composition may include up to 1 gram, up to 0.5 grams, or up to 0.01 grams of dye per 100 grams of composition.

A composition may be formed by mixing a carrier fluid, one or more light activated compounds, and one or more mechanical system sealants. In some embodiments, a carrier fluid, one or more additives, one or more light activated compounds, and one or more mechanical sealants may be mixed together. In some embodiments, the composition may include from about 0.00001 grams to about 10 grams, from about 0.001 grams to about 1 gram, or from about 0.01 grams to about 0.1 gram of light activated compound per 100 grams of composition. Mixing of the ingredients may be performed at a temperature ranging from about 10° C. to about 200° C., from about 25° C. to about 100° C., or from about 50° C. to about 90° C. The combined ingredients may be mixed for about 0.5 hour, about 1 hour, about 2 hour, or up to 24 hours to form the composition. In some embodiments, the mechanical system sealant may be partially soluble and/or suspended in the composition.

Table 1 lists representative ranges of compounds in compositions to detect and seal leaks in an engine oil system.

TABLE 1

| | Volume % (based on total volume of composition) | | | | | | | | | |
|---|---|---|---|---|---|---|---|---|---|---|
| Compound | 1 | 2 | 3 | 4 | 5 | 6 | 7 | 8 | 9 | 10 |
| Refined Petroleum | 27 | 21 | 39 | 43 | 47 | 53 | 57 | 62 | 64 | 65 |
| Compounds | | | | | | | | | | |
| Anti-foamant | — | — | <1 | — | <1 | — | <1 | — | — | — |
| Dispersant | 5 | — | 5 | 5 | 5 | — | — | — | — | — |
| Friction modifier | — | — | — | — | 1 | — | — | — | — | — |
| Ester | — | 20 | 15 | — | 10 | — | 15 | 10 | — | — |
| Phosphate ester | — | 5 | 10 | — | 10 | 20 | — | 10 | 15 | |
| Alcohol ether | 20 | 30 | 21 | 10 | 10 | 15 | 8 | 5 | 5 | 3 |
| Pour Point | — | 1 | — | — | — | — | 2 | — | — | — |
| Depressant | | | | | | | | | | |
| Sealant | 40 | 20 | 5 | 35 | 10 | 10 | 15 | 10 | 15 | 30 |
| Surfactant | 5 | — | — | 5 | 5 | — | — | — | — | — |
| UV dye | 3 | 3 | 1 | 2 | 1 | 2 | 2 | 3 | 1 | 2 |
| Viscosity modifier | — | — | 2 | — | — | — | — | — | — | — |

Table 2 lists representative ranges of compounds in compositions to detect and seal leaks in a transmission system.

TABLE 2

| | Volume % (based on total volume of composition) | | | | | | | | | |
|---|---|---|---|---|---|---|---|---|---|---|
| Compound | 1 | 2 | 3 | 4 | 5 | 6 | 7 | 8 | 9 | 10 |
| Refined Petroleum | 27 | 21 | 39 | 43 | 47 | 53 | 57 | 62 | 64 | 65 |
| Compounds | | | | | | | | | | |
| Anti-foamant | — | — | <1 | — | <1 | — | <1 | — | — | — |
| Dispersant | 5 | — | 5 | 5 | 5 | — | — | — | — | — |
| Friction modifier | — | — | — | — | 1 | — | — | — | — | — |
| Ester | — | 20 | 15 | — | 10 | — | 15 | 10 | — | — |
| Phosphate ester | — | 5 | 10 | — | 10 | 20 | — | 10 | 15 | |
| Alcohol ether | 20 | 30 | 21 | 10 | 10 | 15 | 8 | 5 | 5 | 3 |
| Pour Point | — | 1 | — | — | — | — | 2 | — | — | — |
| Depressant | | | | | | | | | | |
| Sealant | 40 | 20 | 5 | 35 | 10 | 10 | 15 | 10 | 15 | 30 |
| Surfactant | 5 | — | — | 5 | 5 | — | — | — | — | — |
| UV dye | 3 | 3 | 1 | 2 | 1 | 2 | 2 | 3 | 1 | 2 |
| Viscosity modifier | — | — | 2 | — | — | — | — | — | — | — |

Table 3 lists representative ranges of compounds in compositions to detect and seal leaks in a steering system.

TABLE 3

| | Volume % (based on total volume of composition) | | | | | | | | | |
|---|---|---|---|---|---|---|---|---|---|---|
| Compound | 1 | 2 | 3 | 4 | 5 | 6 | 7 | 8 | 9 | 10 |
| Refined Petroleum | 27 | 21 | 39 | 43 | 47 | 53 | 57 | 62 | 65 | 65 |
| Compounds | | | | | | | | | | |
| Anti-foamant | — | — | <1 | — | <1 | — | <1 | — | — | — |
| Dispersant | 5 | — | 5 | 5 | 5 | — | — | — | — | — |
| Friction modifier | — | — | — | — | 1 | — | — | — | — | — |
| Ester | — | 20 | 15 | — | 10 | — | 15 | 10 | — | — |
| Phosphate ester | — | 5 | 10 | — | 10 | 20 | — | 10 | 16 | |
| Lubrizol 9614G | 20 | 30 | 21 | 10 | 10 | 15 | 8 | 5 | 6 | 6 |
| Pour Point | — | 1 | — | — | — | — | 2 | — | — | — |
| Depressant | | | | | | | | | | |
| Sealant | 40 | 20 | 5 | 35 | 10 | 10 | 15 | 10 | 11 | 27 |
| Surfactant | 5 | — | — | 5 | 5 | — | — | — | — | — |
| UV dye | 3 | 3 | 1 | 2 | 1 | 2 | 2 | 3 | 2 | 2 |
| Viscosity modifier | — | — | 2 | — | — | — | — | — | — | — |

The composition may be packaged in a clear bottle, colored bottle, or metal container. The bottle may be composed of polymeric material and/or glass. The bottle and/or metal container may include an end that is tapered. A tapered end may allow the composition to be added directly to a port of the mechanical system. In some embodiments, the composition may be added to a fluid port of the mechanical system using a funnel or a pressurized pumping system (e.g., a hand pump).

In some embodiments, a composition may be sold and/or packaged as part of a kit. The kit may include a visualization composition, safety glasses and/or UV safety glasses, towels, funnels, a visualization device as described herein, batteries, or combinations thereof. The kit may be packaged in a carrying case with preformed segments to hold the components of the kit. In some embodiments, the carrying case may be plastic and/or include a handle. In some embodiments, the pre-formed segments may be removable.

In some embodiments, a mechanical system may be treated with a composition as described herein to detect and/or seal leaks in the mechanical system. The composition may be added directly to the mechanical system through a port. In some embodiments, the mechanical system may be treated with the composition at the site of manufacture. Addition of the composition at the site of manufacture may enable leaks that develop during the manufacturing process and/or during shipment of new machinery to be detected and sealed.

In some embodiments, the composition may be pre-mixed with an appropriate fluid to form a fluid/composition mixture. Once mixed, the fluid/composition mixture may be added to the mechanical system though the port of the mechanical system.

Once added to the mechanical system, the composition is circulated through the mechanical system for a period of time. For example, the composition may be circulated by starting the system and operating the system at least 1 minute, at least 30 minutes, at least 60 minutes, at least 4 hours, at least 8 hours, at least 3 days, at least 4 days, or up to 1 week. After circulating the composition through the mechanical system, activating light (e.g. UV light) from the visualization device described herein may be directed towards a portion (e.g., the exterior) of one or more components of the mechanical system. If a leak is present in the mechanical system, the light activated compound would be visible to the eye when activated by the activating light.

Visualization of the light activated compound(s) with the activating light source portion of the visualization device described herein may indicate the source(s) of leak(s). Once the source of the leak is detected, the composition may be removed from the site of the source. For example, a person may wipe a cloth over components of the mechanical system to remove any fluid from the components. The composition may then be continuously circulated through the mechanical system for a period of time. As the composition circulates through the mechanical system, the leak may be sealed with the mechanical system sealant. The leak area may be monitored with the activating light source. Confirmation that the leak is sealed may be obtained by directing activating light towards the mechanical system and noting when little or none of the light activated compound is detected.

In some embodiments, the mechanical system may be monitored for leaks over a period of time. For example, after a period of time and/or a number of miles, activating light from the visualization device may be directed towards a portion of the mechanical system (e.g., towards a portion of the exterior of the mechanical system) to determine if the previously sealed leak is still sealed, or if any new leaks are present. Examples of time periods include, but are not limited to, at least 100 hours, at least 500 hours, at least 700 hours, at least 1,000 hours, at least 1,500 hours, at least 2,000 hours, or at least 30,000 hours. Examples of miles for engine systems, transmission systems and/or power steering systems include, but are not limited to at least 1,000 miles, at least 2,000 miles, at least 3,000 miles, at least 5,000 miles, or at least 7,500 miles. In some embodiments, the composition may be removed from the mechanical system by removing the fluid from the system and/or flushing the mechanical system with fresh fluid.

In some embodiments, the mechanical system may be monitored for leaks and/or temperature changes using the visualization device described herein. The infrared light from the visualization device may be aimed at a portion of the mechanical system (e.g., an air-conditioning vent) and the temperature of the system and/or air around the system may be determined. Assessment of the temperature of the system may assist in evaluating the performance of the components of the system. If the temperature is not within a desired range the mechanical system may be monitored for leaks using the techniques and the visualization devices described herein. For example, after the temperature of a component of a refrigeration system and/or air around the component is determined to be too high (e.g., a temperature of 70° F. when a refrigeration system is at maximum cooling) a user may look for leaks in the air-conditioning system. The leaks may be detected by passing the white light source from the visualization device over components of the refrigeration system and looking for leaks that may be visually detected. Alternatively, if the visualization device includes an activating light source, a composition as described herein may be added to the refrigeration system and circulated through the system. After circulating the composition through the refrigeration system, activating light (e.g. UV light) from the visualization device described herein may be directed towards a portion (e.g., the exterior) of one or more components of the refrigeration system. If a leak is present in the refrigeration system, the light activated compound would be visible to the eye when activated by the activating light.

In this patent, certain U.S. patents have been incorporated by reference. The text of such U.S. patents is, however, only incorporated by reference to the extent that no conflict exists between such text and the other statements and drawings set forth herein. In the event of such conflict, then any such conflicting text in such incorporated by reference U.S. patents is specifically not incorporated by reference in this patent.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those described herein, processes may be reversed, and certain features of the invention may be utilized independently, all as would be apparent to one skilled in the art after having the benefit of this description to the invention. Changes may be made in the elements described herein without departing from the spirit and scope of the invention as described in the following claims. In addition, it is to be understood that features described herein independently may, in certain embodiments, be combined.

What is claimed is:

1. A visualization device, comprising:
a body, wherein the body comprises a cavity configured to receive one or more power sources;
one or more infrared light sources configured to produce infrared light at or proximate an end of the body; and
one or more activating light sources positioned at or proximate an end of the body that is substantially opposite to the infrared light source, wherein the one or more activating light sources are configured to produce activating light; and
wherein one or more of the infrared light sources and one or more of the activating light sources are separately or jointly coupled to one or more of the power sources positioned within the cavity.

2. The visualization device of claim 1, wherein at least one of the power sources is positioned between at least one of the activating light sources and at least one of the infrared light sources.

3. The visualization device of claim 1, wherein one or more of the infrared light sources is positioned in the cavity of the body.

4. The visualization device of claim 1, wherein one or more of the activating light sources is positioned in the cavity of the body.

5. The visualization device of claim 1, further comprising two function switches configured to contact a control component coupled to at least one of the power sources, wherein the control component is configured to activate at least one of the infrared light sources and at least one of the activating light sources when contacted with at least one of the function switches.

6. The visualization device of claim 1, further comprising at least one function switch configured to contact a control component coupled to at least one of the power sources, wherein the control component is configured to turn off at least one of the light sources when contacted with the function switch.

7. The visualization device of claim 1, further comprising one or more white lights sources positioned proximate the one or more infrared light sources.

8. The visualization device of claim 1, wherein one or more of the activating light sources comprises one or more light emitting diodes.

9. The visualization device of claim 1, wherein at least one of the activating light sources is a blue light emitting diode.

10. The visualization device of claim 1, wherein at least one of the activating light sources is a green light emitting diode.

11. The visualization device of claim 1, wherein at least one of the activating light sources is an ultraviolet light.

12. The visualization device of claim 1, wherein at least one of the infrared light sources is a laser.

13. A method of for detecting one or more leaks a mechanical system containing one or more fluids, comprising:
directing infrared light towards at least a portion of the mechanical system;
determining the temperature at least one component of the mechanical system;
directing activating light towards at least a portion of the mechanical system, and
detecting a leak in the mechanical system by visualizing one or more light activated compounds in at least one of the fluids with the activating light;
wherein the infrared light and the activating light are provided by a visualization device comprising:
a body, wherein the body comprises a cavity configured to receive one or more power sources;
one or more infrared light sources configured to produce infrared light at or proximate an end of the body; and
one or more activating light sources positioned at or proximate an end of the body that is substantially opposite to the infrared light source, wherein the one or more activating light sources are configured to produce activating light; and
wherein one or more of the infrared light sources and one or more of the activating light sources are separately or jointly coupled to one or more of the power sources positioned within the cavity.

14. The method of claim 13, wherein at least one of the light activated compounds comprises a fluorescent compound.

15. The method of claim 13, wherein producing activating light comprises depressing a function switch of the visualization device at least once to active one of the light sources.

16. The method of claim 13, wherein producing infrared light comprises depressing a function switch of the visualization device at least once to active one of the light sources.

17. The method of claim 13, wherein determining the temperature comprises displaying the temperature on a display panel positioned in the body of the visualization device in degrees Fahrenheit and sliding a toggle switch to display the temperature in degrees Centigrade.

18. The method of claim 13, wherein the mechanical system comprises an engine oil system, a transmission system, a power steering system, an air-conditioning system, or combinations thereof.

19. The method of claim 13, further comprising:
introducing a composition into to the mechanical system, the composition comprising one or more mechanical system sealants;
operating the mechanical system after introducing the composition into the mechanical system;
directing activating light toward at least a portion of the mechanical system after inhibiting one or more leaks detected during a previous inspection of the steering system.

20. A kit comprising:
safety glasses; and
a visualization device, wherein the visualization device comprises:
a body, wherein the body comprises a cavity configured to receive one or more power sources;
one or more infrared light sources configured to produce infrared light at or proximate an end of the body; and
one or more activating light sources positioned at or proximate an end of the body that is substantially opposite to the infrared light source, wherein the one or more activating light sources are configured to produce activating light; and
wherein one or more of the infrared light sources and one or more of the activating light sources are separately or jointly coupled to one or more of the power sources positioned within the cavity.

21. A visualization device, comprising:
a body, wherein the body comprises a cavity configured to receive one or more power sources;
one or more infrared light sources configured to produce infrared light at or proximate an end of the body; and
one or more white light sources positioned at or proximate an end of the body that is substantially opposite to the infrared light source, wherein the one or more activating light sources are configured to produce activating light; and
wherein one or more of the infrared light sources and one or more of the white light sources are separately or jointly coupled to one or more power sources positioned within the cavity.

22. The visualization device of claim 20, further comprising one or more activating light sources positioned proximate the one or more infrared light sources.

23. The visualization device of claim 20, wherein at least one of the white activating light sources is an incandescent bulb.
